(19) United States
(12) Patent Application Publication
(10) Pub. No.: US 2011/0278336 A1
(43) Pub. Date: Nov. 17, 2011

(54) PIVOTING HITCH-MOUNTED CARGO CARRIER

(76) Inventor: Keith Landrum, Ovett, MS (US)

(21) Appl. No.: 12/781,270

(22) Filed: May 17, 2010

(51) Int. Cl. B60R 9/06

(52) U.S. Cl. 224/509; 224/519

(57) ABSTRACT

The cargo carrier according to the invention includes only three modular components which are embodied by a carrier frame and two support arms. These three components are easily assembled without the need of any coupling devices in addition to or external from the components themselves. According to the invention, inter-fitting tubular bearings of the carrier support arm and of the carrier frame require no pivot pins yet allow the carrier support arm to swing to various positions behind and to the side of the vehicle. A tubular bearing of the carrier frame is merely dropped into place into a corresponding tubular bearing of the upper support arm in a resting and nesting manner in order to rotate the carrier frame freely relative to the upper arm. In turn a second tubular bearing of the upper support arm is dropped into place into a corresponding tubular bearing of the lower support arm in order to rotate the upper support arm freely relative to the lower arm. The inter-fitting tubular bearing system according to the invention allows for 360° rotation between the carrier frame and an upper support arm, and between the upper support arm and a lower support arm which is mounted to the vehicle in a fixed manner. This arrangement permits a range of positions of the carrier frame relative to the vehicle which heretofore was unachievable with a three component system.

### BACKGROUND OF THE INVENTION

1. Field of the Invention

The present invention relates generally to cargo carriers attachable to vehicles for carrying equipment and the like, and more particularly to an improved swinging cargo carrier which is connected to a vehicle towing hitch.

2. Description of the Prior Art

There are many cargo carriers and other equipment carrying systems available which conventionally attach to the bumper of a vehicle. In the prior art it is known to mount carriers to the hitch receiver of a vehicle on an arm that pivots the carrier away from the back of a vehicle in various fashions. These prior art carriers all suffer one major problem. The assembly and manufacturing of these carriers is complex due to the numerous parts required.

Furthermore it is known in the prior art to provide a carrier frame with a mesh bottom and reinforcing bars. However, attachment of the carrier frame to an arm supporting the carrier frame likewise is complex and requires excessive parts in the prior art.

### OBJECTS AND SUMMARY OF THE INVENTION

It is therefore a general object of the present invention to provide an improved cargo carrier for a vehicle.

Another object of the present invention is to provide a cargo carrier which permits access to the trunk or rear of the vehicle without dismounting the cargo or carrier from the vehicle.

A further object is to provide a cargo carrier for a vehicle which may be easily connected and disconnected from the vehicle.

Still another object of the invention is to minimize the number of parts required for the cargo carrier.

These and other objects of the present invention will be apparent to those skilled in the art.

The cargo carrier according to the invention advantageously has only three modular components. The three components of the cargo carrier are embodied by a carrier frame and two support arms. These three components are easily assembled without the need of any coupling devices in addition to or external from the components themselves. According to the invention, inter-fitting tubular bearings of the carrier support arm and of the carrier frame require no pivot pins yet allow the carrier support arm to swing to various positions behind and to the side of the vehicle.

A tubular bearing of the carrier frame is merely dropped into place into a corresponding tubular bearing of the upper support arm in a resting and nesting manner in order to rotate the carrier frame freely relative to the upper arm. In turn a second tubular bearing of the upper support arm is dropped into place into a corresponding tubular bearing of the lower support arm in order to rotate the upper support arm freely relative to the lower arm.

The inter-fitting tubular bearing system according to the invention allows for 360° rotation between the carrier frame and an upper support arm, and between the upper support arm and a lower support arm which is mounted to the vehicle in a fixed manner. This arrangement permits a range of positions of the carrier frame relative to the vehicle which heretofore was unachievable with a three component system.

The cargo carrier for vehicles according to the invention includes the lower support arm extending generally parallel to the rearward bumper of the vehicle which is connectable in a fixed relation to the vehicle hitch. The swinging upper arm is pivotally connected to the lower arm and includes a horizontally extending portion and a vertical tubular bearing. The upper arm is connected to the lower arm such that the tubular bearing will swing through an arc away from the rearward end of the vehicle. A carrier frame is mounted similarly by a vertical tubular bearing provided on an underside thereof, which is pivotally connected in turn to the upper swinging arm. Advantageously, both the upper swinging arm and the carrier frame are pivotally mounted, which provides a maximum range of positions of the carrier frame relative to the rear of the vehicle.

The cargo carrier according to the invention advantageously can be easily dismantled and stored when not needed or in use.

### BRIEF DESCRIPTION OF THE DRAWINGS

FIG. 1 is a pictorial view of the cargo carrier of a first embodiment of the invention mounted on the rear of a vehicle;

FIG. 2 is an exploded perspective view of the cargo carrier of FIG. 1;

FIG. 3 is an underside reverse view of the carrier frame shown in FIG. 2;

FIG. 4 is a pictorial view of the cargo carrier of a second embodiment of the invention mounted on the rear of a vehicle in an opposite manner when compared to FIG. 1; and

FIG. 5 is an exploded perspective view of the cargo carrier of FIG. 4.

### DESCRIPTION OF THE PREFERRED EMBODIMENTS

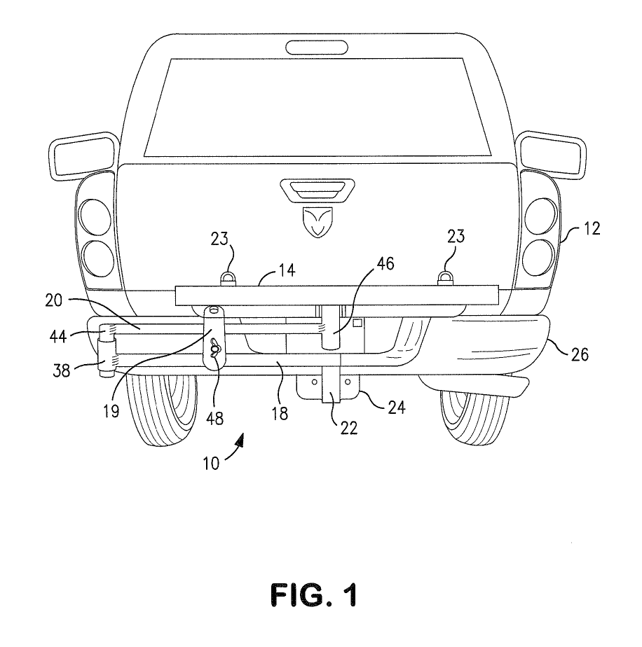

Referring now to the drawings, in which identical or corresponding parts are identified with the same reference numeral, and more particularly to FIG. 1, the hitch cargo carrier of the present invention is designated generally at 10 and is mounted on the rear of the vehicle 12. A carrier frame 14 of the hitch carrier 10 is provided to support whatever cargo is desired to be carried.

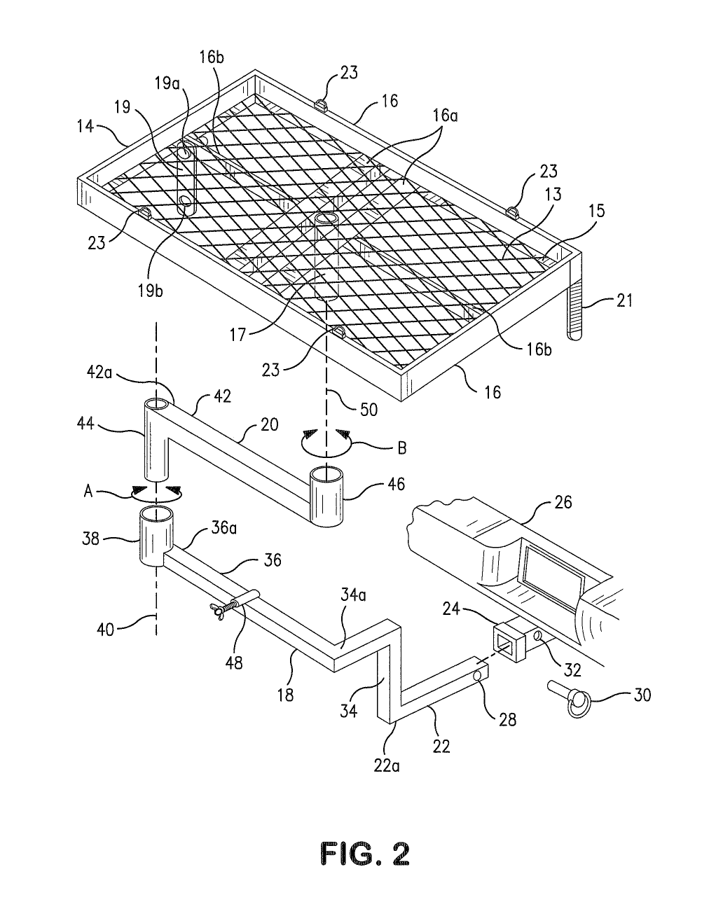

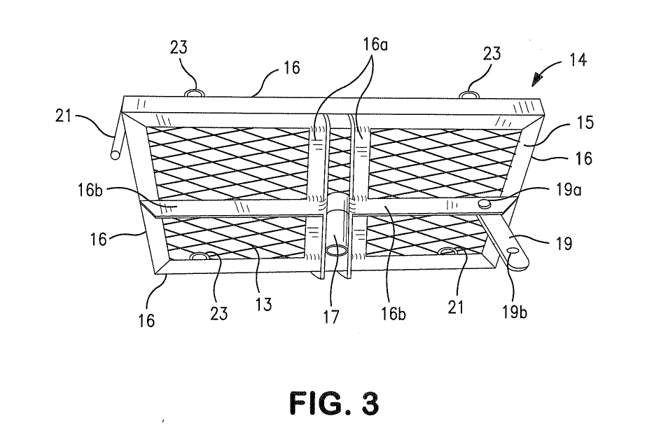

As can be seen from the drawings, the hitch carrier 10 consists of the carrier frame 14 best seen in FIG. 2, a topside view and FIG. 3, an underside, reverse view. An outside perimeter of the carrier frame is dimensioned in the present embodiment as 24″ W×38″ L and is made of four angle iron sides 16 welded together at the four corners of the carrier frame 14. A ¾″×9 gauge expandable metal sheet forms a support surface 13 which is attached by welding to the inside angle iron flanges 15. As best seen in FIG. 3, two additional 24″ parallel angle iron cross bars 16a are mounted approximately 2″ apart and welded centrally to the underside of the carrier frame 14 perpendicular to the 38″ sides of the frame. Additionally a pair of 2″×¼″ flat bars 16b extend in parallel to the 38″ sides along a center of the carrier frame 14 and are welded to the 24″ sides of the carrier frame 14. A 1½″ diameter pipe forms a tubular bearing which is welded perpendicularly to the center of the underside of the carrier frame 14 between the 24″ additional angle irons and the pair of 2″×¼″ flat bars 16b. An additional approximately 6″ flat bar 19 is bolted or welded at one end 19a to one of the above flat bars 16b approximately 3″ in from the outside of the carrier frame 14. This 6″ flat bar 19 has a hole 19b at its other end for receiving a securing bolt at 19a. The carrier frame 14 also is provided with an approximately 5″ handle 21 attached to an outside corner of the carrier frame 14 and extending vertically below it. Additionally, two mounting strap rings 23 are mounted on the outside of each of the 38″ angle iron sides 16 of the carrier frame 14.

The dimensions provided above are of a preferred embodiment for the hitch carrier. It will be understood that the dimensions are not the exclusive sizes of the platform and carrier frame. Depending on the needs and demands of the user of the hitch carrier the platform and carrier frame can be customized to order.

Referring now to FIGS. 1 and 2, hitch carrier 10 includes a lower support arm 18 and an upper swinging support arm 20 which pivotally connects to lower arm 18. Lower support arm 18 includes a horizontally rearwardly extending portion 22 which is designed to be received within a conventional receiving hitch 24, mounted on or below the bumper 26 of vehicle 12. An aperture 28 in rearwardly extending portion 22 will receive a selectively lockable pin 30 which extends through apertures 32 in receiving hitch 24, in a conventional fashion, so as to lock lower support arm 18 in position with respect to bumper 26.

An upstanding portion 34 of lower support arm 18 extends upwardly in the shape of an inverted “L” from the forward end 22a of rearwardly extending portion 22. An elongated horizontal portion 36 extends horizontally and generally parallel to bumper 26 from the upper end 34a of upstanding portion 34.

The free end 36a of elongated portion 36 of the lower support arm 18 has a vertically oriented tubular bearing 38 with which the upper swinging support arm 20 is supported so as to pivot relative thereto, as described in more detail hereinbelow.

Upper swinging support arm 20 includes a horizontally oriented elongated portion 42 having a length generally the same as that of elongated portion 36 of lower support arm 18. A generally vertically oriented tubular bearing 44 is formed in one end 42a of elongated portion 42, and is oriented coaxially with the tubular bearing 38 as indicated by a dashed line. The tubular bearings 38 and 44 are dimensioned to permit the tubular bearing 44 of upper arm 20 to be inter-fitting so as to rest within and be rotatably supported within the tubular bearing 38 of the lower arm 18 about pivot axis 40. Arrow A indicates that the upper arm 20 is able to rotate 360° about axis 40, when unobstructed.

The elongated portion 36 of the upper support arm 20 is embodied preferably as 32″ in length with a vertically upward extending 2″ diameter pipe for its tubular bearing 46 at its right end as viewed in the drawings. The tubular bearing 46 is aligned with the upper end 34a of the upstanding portion 34 of the lower arm 18 at the right end thereof. The lower support arm 18 is provided with a “zigzag” arrangement of a 9″ section, a 9″ section, and a 16″ section in series at right angles to one another, which are in turn orthogonal to the elongated portion 36 of the lower support arm 18, which is also embodied preferably as 32″ in length. The upper support arm 20 at its right end is further provided with a vertically upwardly extending 2″ diameter pipe for forming its tubular bearing 46. This “zigzag” arrangement provides the necessary spacing from the bumper of the vehicle to accommodate the width of the carrier frame, as well as the necessary rigidity to support the carrier frame and its cargo. Note that the lower support arm 18 has a butterfly fixture attached thereto. The use of the butterfly fixture 48 will be described hereinafter.

The dimensions provided above are of a preferred embodiment for the support arms. It will be understood that the dimensions are not the exclusive sizes of the upper and lower support arms. Depending on the needs and demands of the user of the hitch carrier the support arms can be customized to order.

The hitch carrier 10 is assembled on a vehicle 12 by first attaching the lower support arm 18 into the receiving hitch 24. Next the upper support arm 20 has its 1½″ diameter pipe of the tubular bearing 44 inserted into the 2″ diameter pipe of the tubular bearing 38 of the lower support arm 18, which results in the combination shown in FIG. 1. It can be seen that a bottom end of the tubular bearing 44 extends clear through the 2″ diameter pipe of tubular bearing 38. Note that the upper support arm 20 can swivel relative to the lower support arm 18. Next the bottom of the carrier frame 14 shown in FIG. 3 in reverse is mounted on the upper support arm 20 by inserting the 1½″ diameter pipe of tubular bearing 17 on the bottom of the carrier frame 14 into the 2″ diameter pipe of the tubular bearing 46 of the upper support arm 20. Note that the upper and lower arms 20, 18 of the hitch carrier 10 can be prevented from swiveling by connecting the butterfly fixture 48 on the lower support arm 18 to the flat bar 19 on the carrier frame 14 via connecting hole 19b. Since the lower support arm 18 is always stationary and the flat bar 19 overlaps the upper support arm 20, the upper support arm 20 is prevented from swinging the carrier frame 14 away from this fixed position when the butterfly fixture 48 is being used.

It will be understood that the swinging movement of upper arm 20 from the position generally parallel to the rear of vehicle 12, to a position swung outwardly and away from the rear of the vehicle, is enabled by the 360° rotational range of the upper arm 20 relative to the lower arm 18. The location of lower arm 18, at bumper height or below, permits easy access to the rear of the vehicle 12 when upper arm 20 is swung or pivoted on pivot pin 40. Additionally, the inter-fitting connection of the tubular bearing 17 of the carrier frame 14 with the tubular bearing 46 of the upper arm 20, permits 360° rotation about axis 50 of the carrier frame relative to the upper arm 20 when unobstructed, as indicated by arrow B.

Once the butterfly fixture is released, the carrier can be rotated and swiveled to numerous positions. The depending handle on the corner of the carrier permits all these various movements from a position completely behind the vehicle to a position completely to the side of the vehicle adjacent the wheel, which action will be understood by those skilled in the art.

In the first embodiment of the invention depicted in FIGS. 1-3, it can be seen that the hitch carrier 10 is configured so as to swing away from the vehicle bumper 26 and pivot around the rear of the vehicle to the left side when viewed in FIG. 1.

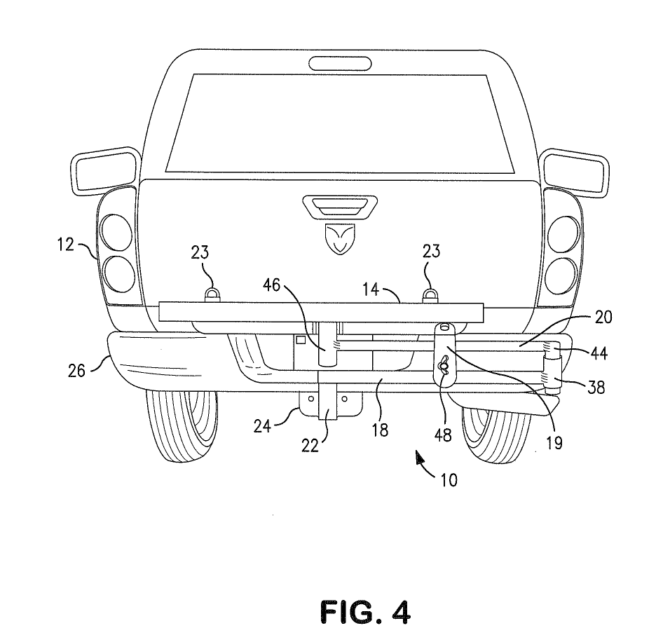

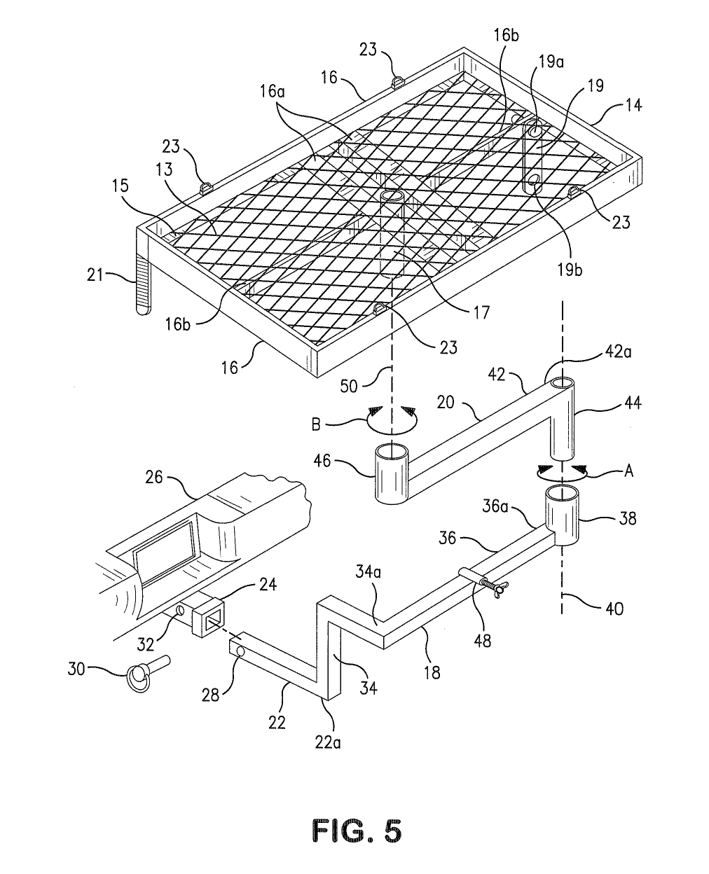

FIG. 4 shows a second embodiment of the cargo carrier of the invention mounted on the rear of the vehicle in an opposite manner when compared to FIG. 1. FIG. 5 is an exploded perspective view of the cargo carrier of FIG. 4. The elements are identical to those in the first embodiment and accordingly are labeled with the reference numerals for the same parts. The difference in the second embodiment is that the hitch carrier 10 is configured so as to swing away from the vehicle bumper 26 and pivot around the rear of the vehicle to the right side when viewed in FIG. 4, opposite to that of the first embodiment. Essentially the lower support arm 18 would be welded to extend to the right side of the rear of the vehicle rather than the left. The carrier frame and upper and lower support arms are constructed in a mirror image, as will be understood by those skilled in the art.

The foregoing relates to a preferred exemplary embodiments of the invention, it being understood that other variants and embodiments thereof are possible within the spirit and scope of the invention, the latter being defined by the appended claims.

1. A cargo carrier for use with a vehicle, having modular component system, to be attached to an attachment place on the vehicle, comprising:
a first modular component embodied by a lower support arm (18) which is attachable in a fixed manner to the attachment place (24) on the vehicle;
a second modular component embodied by an upper swinging support arm (20) which is rotatably supported by the lower support arm (18), the upper arm (20) being rotatably supported by the lower arm (18) in a range up to 360 degrees relative to the lower arm (18), unless inhibited by an obstruction; and
a third modular component which is embodied by a carrier frame (14) intended for carrying cargo, the carrier frame (14) being rotatably supported by the upper arm (20) in a range up to 360 degree relative to the upper arm (20), unless inhibited by an obstruction,
wherein only the three components are needed to enable positioning of the carrier frame relative to the attachment place on the vehicle.

2. The cargo carrier according to claim 1, wherein the lower arm (18) has an integral tubular bearing (38) and the upper arm (20) has a first integral tubular bearing (44) at a first end (42a) thereof which has an inter-fitting connection with the tubular bearing (38) of the lower arm (18), which connection enables the upper arm to rotate 360 degrees relative to the lower arm when unobstructed.

3. The cargo carrier according to claim 1, wherein the upper arm (20) has second integral bearing (46) at a second end thereof and the carrier frame (14) has an integral tubular bearing (17) on an underside thereof which has an inter-fitting connection with the second tubular bearing (46) of the upper arm (18), which connection enables the carrier frame to rotate 360 degrees relative to the upper arm when unobstructed.

4. The cargo carrier according to claim 2, wherein the upper arm (20) has second integral bearing (46) at a second end thereof and the carrier frame (14) has an integral tubular bearing (17) on an underside thereof which has an inter-fitting connection with the second tubular bearing (46) of the upper arm (18), which connection enables the carrier frame to rotate 360 degrees relative to the upper arm when unobstructed.

5. The cargo carrier according to claim 1, wherein pairs of inter-fitting tubular bearings between modular components of the carrier frame and upper arm, and of the upper arm and lower arm respectively, fit together by resting and nesting an upper tubular bearing of a pair into a lower tubular bearing of the pair.

6. The cargo carrier according to claim 2, wherein pairs of inter-fitting tubular bearings between modular components of the carrier frame and upper arm, and of the upper arm and lower arm respectively, fit together by resting and nesting an upper tubular bearing of a pair into a lower tubular bearing of the pair.

7. The cargo carrier according to claim 3, wherein pairs of inter-fitting tubular bearings between modular components of the carrier frame and upper arm, and of the upper arm and lower arm respectively, fit together by resting and nesting an upper tubular bearing of a pair into a lower tubular bearing of the pair.

8. The cargo carrier according to claim 1, wherein each of the components has at least one inter-fitting tubular bearing which cooperatingly rests in and nests with an associated tubular bearing of another component.

9. The cargo carrier according to claim 2, wherein each of the components has at least one inter-fitting tubular bearing which cooperatingly rests in and nests with an associated tubular bearing of another component.

10. The cargo carrier according to claim 3, wherein each of the components has at least one inter-fitting tubular bearing which cooperatingly rests in and nests with an associated tubular bearing of another component.

11. The cargo carrier according to claim 5, wherein each of the components has at least one inter-fitting tubular bearing which cooperatingly rests in and nests with an associated tubular bearing of another component.

12. The cargo carrier according to claim 1, wherein the carrier frame is provided with a support surface which is reinforced by underlying crossbars.

13. The cargo carrier according to claim 1, wherein a securing fixture is made integrally with at least one of the modular components which fixture secures the modular components from movement therebetween.

14. The cargo carrier according to claim 1, wherein the carrier frame is provided with cargo securing means for enabling the cargo to be secured onto the carrier frame.

15. The cargo carrier according to claim 1, a handle for maneuvering is provided on at least one of the modular components.

16. The cargo carrier according to claim 1, wherein the place of attachment on the vehicle is a conventional hitch receiver.

17. The cargo carrier according to claim 1, wherein the three components are configured so as to position the carrier frame relative to the attachment place on the vehicle in a clockwise range of positions.

18. The cargo carrier according to claim 16, wherein the three components are configured so as to position the carrier frame relative to the attachment place on the vehicle in a clockwise range of positions.

19. The cargo carrier according to claim 1, wherein the three components are configured so as to position the carrier frame relative to the attachment place on the vehicle in a counter-clockwise range of positions.

20. The cargo carrier according to claim 16, wherein the three components are configured so as to position the carrier frame relative to the attachment place on the vehicle in a counter-clockwise range of positions.
